(19) United States
(12) Patent Application Publication
(10) Pub. No.: US 2025/0038609 A1
(43) Pub. Date: Jan. 30, 2025

(54) ARMATURE AND ROTATING ELECTRICAL MACHINE

(71) Applicant: DENSO CORPORATION, Kariya-city (JP)

(72) Inventors: Ryo Mitani, Kariya-city (JP); Naoto Natsume, Kariya-city (JP); Masayuki Echizen, Kariya-city (JP)

(73) Assignee: DENSO CORPORATION, Kariya-city (JP)

(21) Appl. No.: 18/909,150

(22) Filed: Oct. 8, 2024

Related U.S. Application Data
(63) Continuation of application No. PCT/JP2023/006884, filed on Feb. 24, 2023.

(30) Foreign Application Priority Data
Apr. 19, 2022 (JP) 2022-068844

(51) Int. Cl. H02K 3/52

(52) U.S. Cl. CPC H02K 3/522; H02K 2203/12

(57) ABSTRACT

A stator is provided which includes, a stator core which includes teeth, an insulator, a plurality of coils each of which is made of a winding of a conductive wire around a respective one of the teeth, and a terminal. The first terminal is made from elastic conductive material and includes a first insulator retainer, a first connector, and a second connector. The first connector extends from the first insulator retainer and includes a crimp to which a coil end of the coils is secured. The second connector includes a power supply connector which extends from the first insulator retainer and is connected to a power supply connector leading to a power supply. The second connector also includes a first bend and a second bend on which mechanical stress is exerted with the power supply connector being connected to the power supply.

### CROSS REFERENCE TO RELATED DOCUMENT

The present application claims the benefit of priority of Japanese Patent Application No. 2022-068844 filed on Apr. 19, 2022, the disclosure of which is incorporated in its entirety herein by reference.

### TECHNICAL FIELD

This disclosure relates generally to an armature and a rotating electrical machine.

### BACKGROUND ART

The first patent literature listed below teaches a rotating electrical machine in the form of an inner-rotor brushless motor which includes a stator, a plurality of magnetic poles on which coils are disposed, and a plurality of conductive members. The conductive members are electrically connected to ends of the coils using a plurality of connectors. Each of the connectors is disposed between an adjacent two of the magnetic poles of the stator. This layout reduces the size of the rotating electrical machine in an axial direction thereof.

### PRIOR ART DOCUMENT

### Patent Literature

FIRST PATENT LITERATURE: Japanese Patent First Publication No. 2020-99174

### SUMMARY OF THE INVENTION

Typical rotating electrical machine installed vehicles usually need to have a high degree of resistance to mechanical vibration.

It is an object of this disclosure to provide an armature and a rotating electrical machine capable of ensuring a required degree of resistance to mechanical vibration.

According to one aspect of this disclosure, there is provided an armature is provided which comprises: (a) an armature core which includes teeth arranged at intervals away from each other in a circumferential direction of the armature; (b) an insulator secured to the armature core; (c) a plurality of coils each of which is made of a winding of a conductive wire around a respective one of the teeth; and (d) a terminal which is made from elastic conductive material and includes an insulator retainer secured to the insulator, a first connector, and a second connector. The first connector extends from the insulator retainer and includes a crimp to which a coil end of the coils is secured. The second connector includes a power supply connector which extends from one of the insulator retainer and the first connector and is connected to a power supply connector. The second connector also includes a stress concentrator on which stress concentrates with the power supply connector being connected to a power supply.

The above structure ensures a required degree of resistance to mechanical vibration acting on the armature.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a schematic view which illustrates a motor, as viewed in an a xial direction thereof, according to the first embodiment;

FIG. 2 is a perspective view which illustrates a stator;

FIG. 3 is a plan view which illustrates a stator;

FIG. 4 is an enlarged plan view which illustrates a portion of a stator in which a first terminal is arranged;

FIG. 5 is a perspective view which illustrates a first terminal, as viewed in a first circumferential direction of a stator;

FIG. 6 is a perspective view which illustrates a first terminal, as viewed from radially inside a stator;

FIG. 7 is a perspective view which illustrates cross sections of a first terminal and a portion of a stator, as taken in an axial direction of the stator;

FIG. 8 is a perspective view which illustrates a second terminal;

FIG. 9 is a side view which illustrates a second terminal, as viewed from radially inside a stator;

FIG. 10 is a perspective view which illustrates a first terminal of a motor according to the second embodiment, as viewed in a second circumferential direction of a stator;

FIG. 11 is a perspective view which illustrates a first terminal of a motor according to the third embodiment, as viewed in a second circumferential direction of a stator;

FIG. 12 is a perspective view which illustrates a first terminal of a motor according to the fourth embodiment, as viewed in a second circumferential direction of a stator; and

FIG. 13 is a perspective view which illustrates a first terminal of a motor according to the fifth embodiment, as viewed in a second circumferential direction of a stator.

### MODE FOR CARRYING OUT THE INVENTION

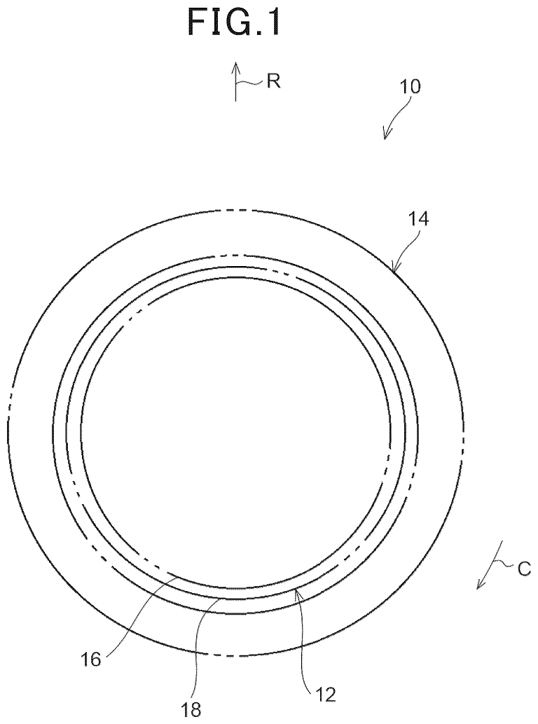

The electrical motor 10 according to the first embodiment will be described below with reference to FIGS. 1 to 9. In the drawings, arrows Z, R, and C indicate a first axial direction, a radially outward direction, and a first circumferential direction of the rotor 12, respectively, which will be referred to later in detail. In the following discussion, an axial direction, a radial direction, and a circumferential direction represent a direction in which a rotational axis of the rotor 12 extends, a direction perpendicular to a direction in which the rotor 12 rotates, and the direction in which the rotor 12 rotates, respectively, unless otherwise specified. The motor 10, as referred to in this disclosure, is an example of a rotating electrical machine.

The motor 10 is, as can be seen from FIG. 1, implemented by an inner-rotor brushless motor. The motor 10 includes the stator 14 working as an armature and the rotor 12 disposed radially inside the stator 14.

The rotor 12 includes the rotor core 16 secured to a rotational shaft, not shown, and magnets 18 attached to an outer peripheral surface of the rotor core 16. The magnets 18 are made of, for example, ring magnets. The magnets 18 are arranged adjacent to each other in the circumferential direction to have N-poles and S-poles which alternately appear on radial outsides of the magnets 18. The magnets 18 may alternatively be secured to an inner peripheral surface of the rotor core 16 to have the N-poles and S-poles which alternately appear on radial insides of the magnets 18 in the circumferential direction.

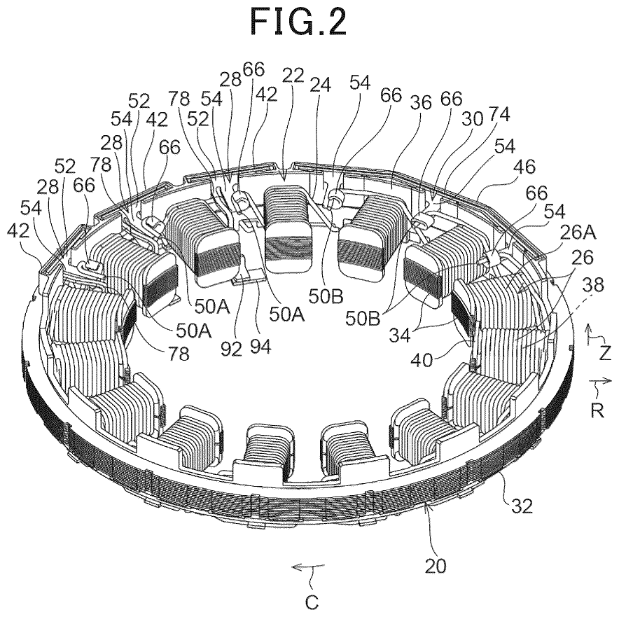

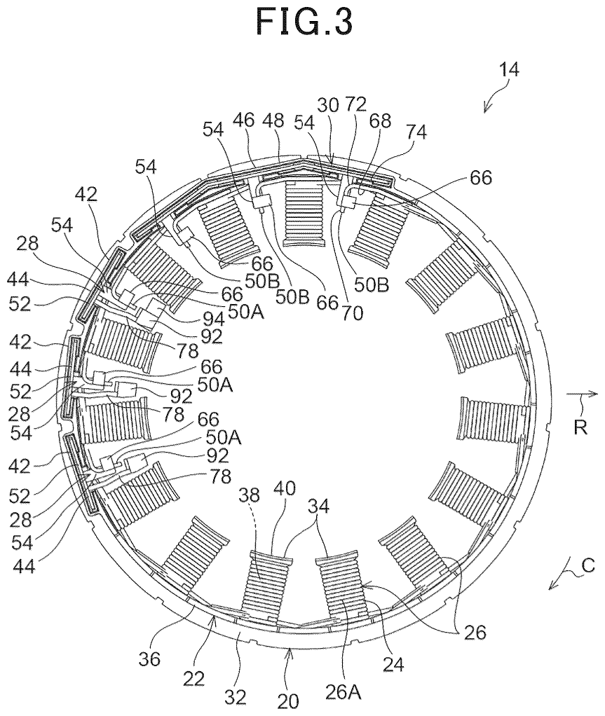

The stator 14, as shown in FIG. 2, includes the stator core 20 (i.e., an armature core), the insulator 22 secured to the stator core 20, and a plurality of coils 26 each of which is made of a winding of a conductor disposed on the stator core 20. The stator 14 is, as illustrated in FIGS. 2 and 3, equipped with three first terminals 28 and a single second terminal 30 to which ends of the coils 26 are electrically connected.

The stator core 20 is formed by steel plates which are made from soft magnetic material and stacked on one another in the axial direction. Each of the steel plates is produced by punching steel sheet into a desired shape. The stator core 20 includes the annular body 32 and the teeth 34 protruding radially inward from the annular body 32. The fifteen teeth 34 are, as clearly illustrated in FIG. 3, arranged at equal intervals away from each other in the circumferential direction.

The insulator 22 is made from an electrically insulating resin material and, as clearly illustrated in FIGS. 2 and 3, includes the annular cover 36 disposed to extend along an inner peripheral surface of the annular body 32 of the stator core 20.

The insulator 22 also includes the tooth covers 38 protruding radially inward from the annular cover 36. The tooth covers 38 are provided one for each of the teeth 34 of the stator core 20. Each of the tooth covers 38 covers an area of a corresponding one of the teeth 34 on which the coil 26 is arranged.

The insulator 22 also includes the flanges 40 each of which protrudes from a radially inner end of a corresponding one of the tooth covers 38 away from a corresponding one of the teeth 34 and extends in the axial direction. Each of the coils 26 is disposed around a corresponding one of the tooth covers 38 and located between the flange 40 and the annular cover 36. The insulator 22 in this embodiment is made of two sections separate from each other in the axial direction.

The insulator 22, as illustrated in FIG. 3, also includes three first terminal retainers 42 which support the first terminals 28 which will be described later in detail. The first terminal retainers 42 are arranged away from each other on one (which will also be referred to as a first end surface) of axially opposed end surfaces of the annular body 32 of the stator core 20 which faces in the first axial direction. Each of the first terminal retainers 42 has a first circumferential end and a second circumferential end opposed to the first circumferential end in the circumferential direction of the stator 14. The first circumferential end of each of the first terminal retainers 42 is located at the same position as that of a first one of a circumferentially adjacent two of the teeth 34 in the circumferential direction of the stator 14. The first one of the teeth 34 faces in the first circumferential direction of the stator 14. In other words, the first circumferential end of each of the first terminal retainers 42 is located in coincidence with the first one of the teeth 34 in the radial direction of the stator 14. Similarly, the second circumferential end of each of the first terminal retainers 42 is located at the same position as that of a second one of a circumferentially adjacent two of the teeth 34 in the circumferential direction of the stator 14. The second one of the teeth 34 faces in the second circumferential direction opposite the first circumferential direction of the stator 14. Each of the first terminal retainers 42 has a circumferential center aligned with a middle between a circumferentially adjacent two of the teeth 34 in the radial direction of the stator 14. In this embodiment, the three first terminal retainers 42 are circumferentially arranged in a region extending over four of the teeth 34 adjacent to each other in the circumferential direction. Each of the first terminal retainers 42 has formed therein the first terminal socket 44 working as a terminal coupling in the form of a fitting recess. Each of the first terminal sockets 44 is of a concave shape with an opening facing in the first axial direction.

The insulator 22 also includes the second terminal retainer 46 which holds the second terminal 30 which will be described later in detail. The second terminal retainer 46 is disposed on the first end surface of the annular body 32 of the stator core 20. The second terminal retainer 46 extends over a region where four of the teeth 34 are arranged adjacent to each other in the circumferential direction. The second terminal retainer 46 is located on a first circumferential side of a circumferentially outermost one of the first terminal retainers 42 which faces in the first circumferential direction of the stator 14. In other words, the second terminal retainer 46 is arranged circumferentially adjacent to the circumferentially outermost one of the first terminal retainers 42. The second terminal retainer 46 has formed therein the second terminal socket 48 working as a terminal coupling. The second terminal socket 48 is of a concave shape with an opening facing in the first axial direction. The structure of the second terminal socket 48 will also be described below in detail.

Each of the coils 26 is made by winding the copper wire 24 around a corresponding one of the teeth 34 of the stator core 20 through the insulator 22. In this embodiment, the coils 26 includes five U-phase coils 26, five V-phase coils 26, and five W-phase coils 26 which are disposed around the teeth 34. The U-phase coils 26, the V-phase coils 26, and the W-phase coils 26 are arranged in this order in the circumferential direction. The U-phase coils 26, the V-phase coils 26, and the W-phase coils 26 are connected in series with each other.

The wire 24 which forms the five U-phase coils 26 has two ends: the first U-phase end 50A and the second U-phase end 50B.

Similarly, the wire 24 which forms the five V-phase coils 26 has two ends: the first V-phase end 50A and the second V-phase end 50B.

Similarly, the wire 24 which forms the five W-phase coils 26 has two ends: the first W-phase end 50A and the second W-phase end 50B.

The first U-phase end 50A, the first V-phase end 50A, and the first W-phase end 50A are, as illustrated in FIGS. 3, 4, and 5, connected to the first terminals 28, respectively. The second U-phase end 50B, the second V-phase end 50B, and the second W-phase end 50B are connected to the second terminal 30.

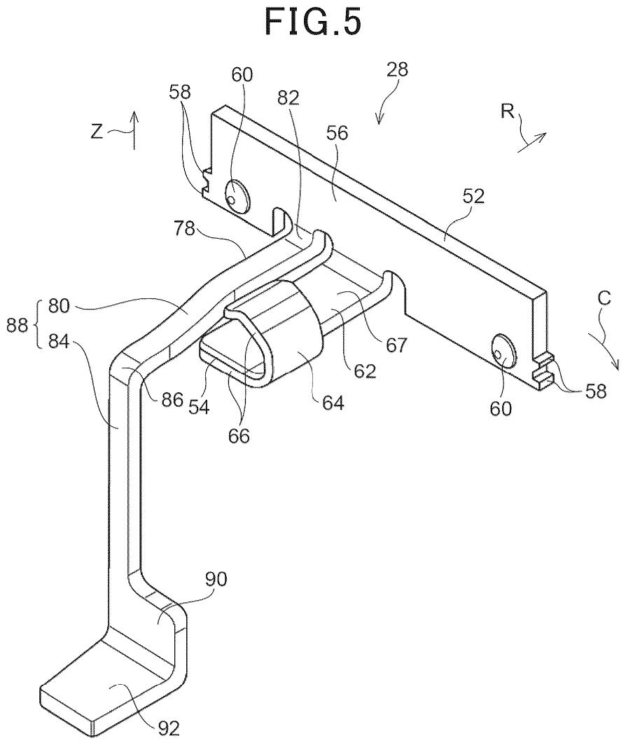

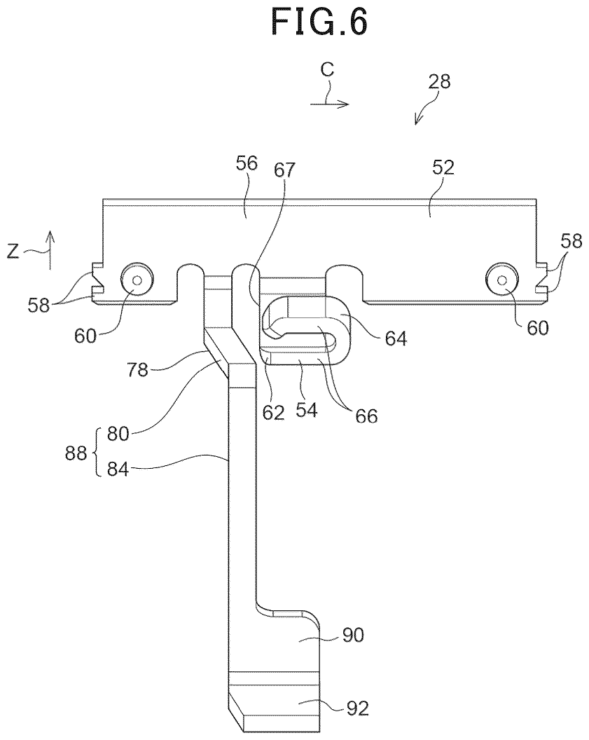

Each of the first terminals 28 is, as clearly illustrated in FIGS. 5 and 6, made by pressing a copper plate into a desired shape. Each of the first terminals 28 includes the first insulator retainer 52 which is of a rectangular shape with a thickness in the radial direction and serves as an insulator holder. Each of the first terminals 28 also includes the first connector 54 which extends radially inward from a portion (which will also be referred to below as a second side portion) of the first insulator retainer 52 which is located both at the circumferential center thereof and at one of axially opposed side surfaces which faces in the second axial direction of the stator 14 (i.e., the rotor 12). Each of the first terminals 28 also includes the second connector 78 which extends radially inward from the second side portion of the first insulator retainer 52 which is located both at the circumferential center thereof and at one of axially opposed side surfaces which faces in the second axial direction of the stator 14. The second connector 78 is, as clearly illustrated in FIGS. 5 and 6, arranged adjacent to the first connector 54.

The first insulator retainer 52 includes the rectangular base 56 having a length extending in the circumferential direction and a width in the axial direction. The first insulator retainer 52 also includes a plurality of (two in this embodiment) press-fit protrusions 58 which are formed on a first end of the base 56 which faces in the first circumferential direction and extend from a portion of the first end which is located close to the second side surface of the first insulator retainer 52 which faces in the second axial direction. The first insulator retainer 52 also includes a plurality of (two in this embodiment) press-fit protrusions 58 which are formed on a second end the base 56 which faces in the second circumferential direction and extend from a portion of the second end which is located close to the second side surface of the first insulator retainer 52 which faces in the second axial direction. Each of the press-fit protrusions 58 is of a saw-tooth shape, as viewed in the radial direction. The first insulator retainer 52 also has the backlash-filling protrusions 60 which are formed on circumferentially opposed end portions of the base 56 and located close to the second side surface of the first insulator retainer 52. The backlash-filling protrusions 60 protrude radially inward.

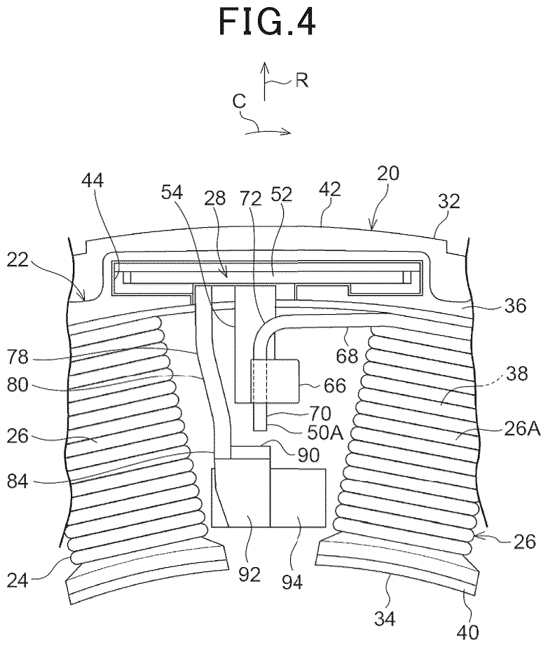

The first connector 54 includes the rectangular base 62 having a length in the radial direction and a width in the circumferential direction. The first connector 54 also includes the extension 64 which extends from a radially inner end portion of the base 62 in the first circumferential direction and has an end portion which is separate from the base 62 and curved or bent in the second circumferential direction. The extension 64 defines the crimp barrel 66 along with the radially inner end portion of the base 62. The crimp barrel 66 works as a crimp to create electrical connection and has an opening facing in the second circumferential direction. The above-described first end 50A is, as illustrated in FIG. 4, firmly gripped by the crimp barrel 66 to achieve a joint of the first end 50A with the crimp barrel 66. The first connector 54, as illustrated in FIGS. 5 and 6, also includes the first intermediate portion 67 located radially outside the crimp barrel 66 of the base 62.

The second connector 78 is discrete from the first connector 54 and located away from a side of the first connector 54 which faces in the second circumferential direction. In other words, the second connector 78 is arranged at a given interval away from the first connector 54 in the circumferential direction of the stator core 20. The second connector 78 includes the first leg 80 which is bent radially inwardly from the second side portion of the first insulator retainer 52. In this embodiment, the first leg 80 has a length which extends in the radial direction and is greater than that of the base 62 of the first connector 54. The first leg 80 has an end which leads to the first insulator retainer 52 and defines the first bend 82 of an L-shape working as a stress concentrator. The second connector 78 also includes the second leg 84 which extends from a radially inner end of the first leg 80 in the second axial direction. A boundary between the second leg 84 and the first leg 80 defines the second bend 86 of an L-shape working as a stress concentrator. The second leg 84 and the first leg 80 define the second intermediate portion 88 of the second connector 78. The second intermediate portion 88 is smaller in width than the first intermediate portion 67 of the first connector 54. The second connector 78 also includes the wide portion 90 which extends in the first circumferential direction from an end (which will also be referred to as a second end) of the second leg 84 which faces in the second axial direction. The second connector 78 also includes the power supply connector 92 which extends radially inward both from the second end of the second leg 84 and from an end (which will also be referred to as a second end) of the wide portion 90 which faces in the second axial direction. A major portion of the wide portion 90 and a major portion of the power supply connector 92 are, as can be seen in FIG. 6, located at the same circumferential position as the crimp barrel 66 of the first connector 54, in other words, aligned with the crimp barrel 66 in the axial direction of the stator core 20.

The first insulator retainer 52 of each of the first terminals 28 is, as can be seen in FIG. 4, inserted into the first terminal socket 44 of the insulator 22, thereby securing the first insulator retainer 52 to the insulator 22 to hold the first terminal 28 in the insulator 22. The first insulator retainer 52 which has been forced into the first terminal socket 44 has the press-fit protrusions 58 firmly fit on the inner wall of the first terminal socket 44 (see FIG. 5), thereby ensuring the stability in retaining the first insulator retainer 52 in the insulator 22. When the first insulator retainer 52 is retained in the insulator 22, the press-fit protrusions 58 on the first end of the first insulator retainer 52 which face in the first circumferential direction are, as can be seen from FIGS. 2, 3, 4, and 5, located circumferentially at the same position as that of one of a circumferentially adjacent two of the teeth 34 which is arranged close to the first end of the first insulator retainer 52, in other words, aligned with the one of the teeth 34 in the radial direction of the stator 14. Similarly, the press-fit protrusions 58 on the second end of the first insulator retainer 52 which face in the second circumferential direction are located at the same position as that of one of a circumferentially adjacent two of the teeth 34 which is arranged close to the second end of the first insulator retainer 52, in other words, aligned with the one of the teeth 34 in the radial direction of the stator 14.

When the first insulator retainer 52 is fit in the insulator 22, the first connector 54 is, as can be seen in FIGS. 3, 4, and 7, located at the center between a circumferentially adjacent two of the coils 26.

Similarly, when the first insulator retainer 52 is fit in the insulator 22, the second connector 78 is disposed between a circumferentially adjacent two of the coils 26. The second end of the second leg 84 which defines the second end of the second connector 78 which faces in the second axial direction, the wide portion 90, and the power supply connector 92 are oriented to protrude in the second axial direction between a circumferentially adjacent two of the coils 26.

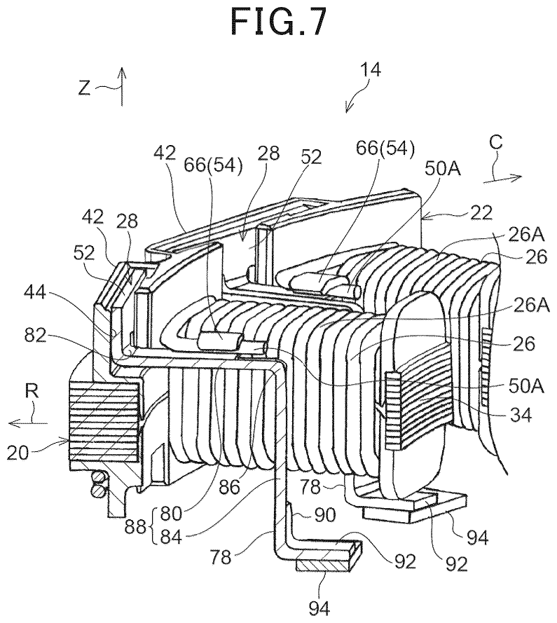

Each of the second connectors 78, as illustrated in FIG. 7, includes the power supply terminal 94 which is located on a lower side of the stator 14, as viewed in the drawings, which will also be referred to as the second axial side. The power supply terminal 94 electrically connects with the power supply. In this embodiment, each of the first terminals 28 has one of the power supply terminals 94 each of which is in the form of a rectangular plate shape having a thickness in the axial direction. The power supply connector 92 of the second connector 78 of each of the first terminals 28 is welded in direct contact with a corresponding one of the power supply terminals 94.

When the power supply connector 92 of each of the second connectors 78 is placed in contact with the power supply terminal 94, a physical load acts on the power supply connector 92 of the second connector 78 in the first axial direction. This causes the second connector 78 to be flexed or deformed in the first axial direction. The flexing of the second connector 78 in the first axial direction results in concentration of stress on the first bend 82 and the second bend 86 and also plastic deformation of the first bend 82 and the second bend 86. The exertion of load on the power supply connector 92 of the second connector 78 in the first axial direction, therefore, causes stress on the first bend 82 to be higher in degree than that on the second bend 86.

Each of the first ends 50A, as can be seen in FIG. 4, has the first section 68 which extends in the second circumferential direction from a radially outer end of one of the coil ends 26A which faces in the first axial direction. The first end 50A also has the second section 70 which extends radially inward (i.e., away from the annular body 32 of the stator core 20) from an end of the first section 68 which faces in the second circumferential direction. The first end 50A also has the flexible section 72 defining a boundary between the first section 68 and the second section 70. The flexible section 72 defines the first section 68 and the second section 70 into an L-shape. The second section 70 of the first end 50A is joined to the crimp barrel 66 of the first terminal 28. In the structure where the first section 68 is designed to extend in the second circumferential direction from a radially inner end of one of the coil ends 26A which faces in the first axial direction, it is advisable that the second section 70 be oriented to extend radially outward (i.e., toward the annular body 32 of the stator core 20) from an end of the first section 68 which faces in the second circumferential direction. The flexible section 72 may be shaped to be moderately curved.

The second section 70 of the first end 50A which is joined to the crimp barrel 66 of the first terminal 28 is, as can be seen in FIGS. 4 and 7, laid along the first major surface of the base 62 of the first connector 54 which faces in the first axial direction Z. The first section 68, the second section 70, and the flexible section 72 of the first end 50A between the first coil ends 26A of a circumferentially adjacent two of the coils 26 which face in the first axial direction Z.

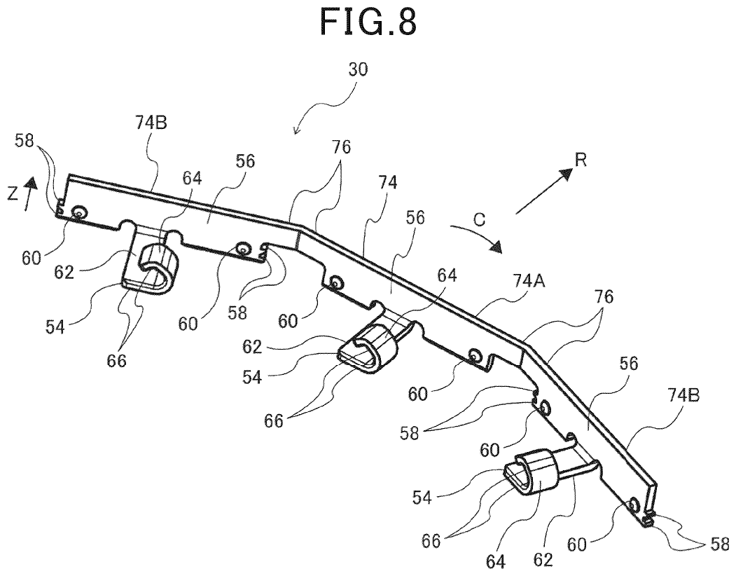

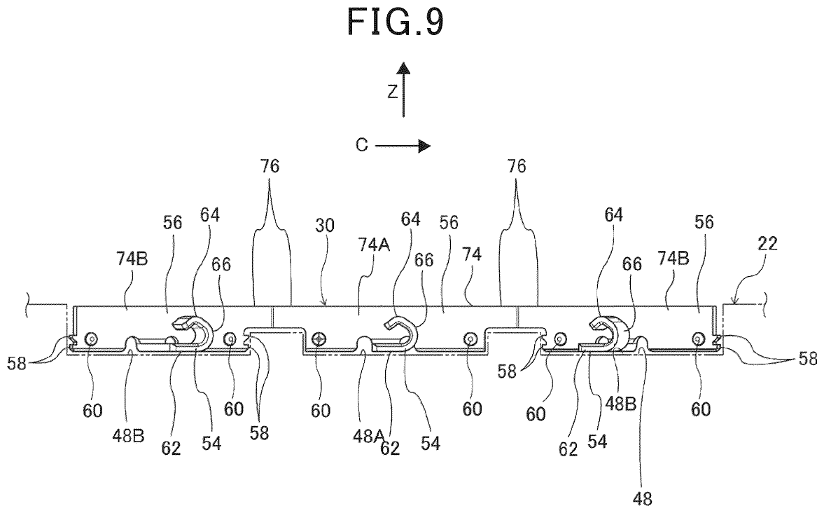

The second terminal 30 is, as can be seen in FIGS. 8 and 9, similar to the first terminals 28, made by pressing a copper conductive plate into a desired shape. The second terminal 30 includes the second insulator retainer 74 which is of a plate-shaped having a thickness in the radial direction and a length in the circumferential direction of the stator 14.

The second insulator retainer 74 has the central securing portion 74A that is defined by a circumferential central portion thereof. The second insulator retainer 74 also has the end securing portions 74B that are defined by end portions thereof facing in the first and second circumferential directions. In the following discussion, one of the end securing portions 74B which faces in the first circumferential direction will also be referred to as the first end securing portion 74B, while the other facing in the second circumferential direction will also be referred to as the second end securing portion 74B.

The central securing portion 74A is identical in structure with the first terminals 28 of the first insulator retainer 52 (see FIG. 5) except that the central securing portion 74A has no press-fit protrusions 58, but includes the connecting tabs 76 extending both from ends of the length thereof which face in the first and second circumferential directions. The connecting tabs 76 are located close to the first side surface of the central securing portion 74A which faces in the first axial direction.

The first end securing portion 74B facing in the first circumferential direction is identical in structure with the first terminals 28 of the first insulator retainer 52 (see FIG. 5) except that the connecting tab 76 extends from a second end of the first end securing portion 74B which faces in the second circumferential direction and is disposed closer to the first side surface of the first end securing portion 74B facing in the first axial direction. The connecting tab 76 of the first end securing portion 74B leads to one of the connecting tabs 76 of the central securing portion 74A which faces in the first circumferential direction.

The second end securing portion 74B facing in the second circumferential direction is identical in structure with the first terminals 28 of the first insulator retainer 52 (see FIG. 5) except that the connecting tab 76 extends from a first end of the second end securing portion 74B which faces in the first circumferential direction and is disposed closer to the first side surface of the first end securing portion 74B facing in the first axial direction. The connecting tab 76 of the second end securing portion 74B leads to one of the connecting tabs 76 of the central securing portion 74A which faces in the second circumferential direction.

Parts of the central securing portion 74A and the end securing sections 74B which are identical with those of the first insulator retainer 52 of each of the first terminals 28 are denoted by the same reference numbers as those in the first insulator retainer 52.

The second terminal 30 also includes three first connectors 54 extending radially inward from second side surfaces of the central securing portion 74A, the first end securing portion 74B, and the second end securing portion 74B which face in the second axial direction. The first connectors 54 are arranged at equal interval away from each other in the circumferential direction. Each of the first connectors 54 of the second terminal 30 is identical in structure with that of the first terminals 28. The same parts of the first connectors 54 of the second terminal 30 as those of the first terminals 28 are denoted by the same reference numbers. The above-described second ends 50B are, as illustrated in FIGS. 2 and 3, held by the crimp barrels 66 of the first connectors 54 to electrically connect the second ends 50B to the crimp barrels 66 of the first connectors 54.

The second insulator retainer 74 of the second terminal 30 is, as illustrated in FIGS. 3 and 9, fit in the second terminal socket 48 of the insulator 22. The second terminal socket 48, as can be seen in FIG. 9, has the central fit recess 48A which is formed in a circumferentially central portion of the bottom of the second terminal socket 48 and in which a second side portion of the central securing portion 74A which faces in the second axial direction is fit. The second terminal socket 48 also has the side fit recess 48B (which will also be referred to as the first side fit recess 48B) which is formed in a first circumferential side portion of the bottom of the second terminal socket 48 facing in the first circumferential direction and in which a second side portion of the first end securing portion 74B which faces in the second axial direction is fit. The second terminal socket 48 also has the side fit recess 48B (which will also be referred to as the second side fit recess 48B) which is formed in a second circumferential side portion of the bottom of the second terminal socket 48 facing in the second circumferential direction and in which a second side portion of the second end securing portion 74B which faces in the second axial direction is fit. When the second insulator retainer 74 of the second terminal 30 is fit in the second terminal socket 48 of the insulator 22, the second side portion of the central securing portion 74A which faces in the second axial direction is fit in the central fit recess 48A. Simultaneously, the second side portion of the first and second end securing portions 74B which face in the second axial direction are also fit in the side fit recesses 48B. This secures the second insulator retainer 74 to the insulator 22, so that the second terminal 30 is retained by the insulator 22. When the second side portions of the first and second end securing portions 74B are fit in the side fit recesses 48B, the press-fit protrusions 58 are press-fit on the inner walls of the side fit recesses 48B, thereby ensuring the stability in holding the second insulator retainer 74 by the insulator 22. The press-fit protrusions 58 of the second terminal 30 are, like those of the first terminals 28, located at the same positions as the selected teeth 34 in the circumferential direction. Each of the three first connectors 54 of the second terminal 30 is, as can be seen in FIG. 3, located at the center between a circumferentially adjacent two of the teeth 34.

The second ends 50B are, as can be seen from FIG. 3, identical in structure with the first ends 50A. The same parts of the second ends 50B as those of the first ends 50A are denoted by the same reference numbers. The second section 70 of each of the U-phase, V-phase, and W-phase second ends 50B is joined to a corresponding one of the crimp barrels 66 of the second terminal 30.

### Operation and Beneficial Advantage of this Embodiment

The operation of and beneficial advantages offered by this embodiment will be descried below.

The motor 10 in this embodiment is, as can be seen in FIGS. 1, 2, 3, 4, and 7, operated by switching application of voltage among the power supply connectors 92 of the second connectors 78 of the first terminals 28 to change a flow of electrical current among the U-phase, V-phase, and W-phase coils 26, thereby creating a rotating magnetic field around the stator 14 to rotate the rotor 12.

The motor 10 in this embodiment is, as described above, designed to have the first terminals 28 and the second terminal 30 each of which is arranged between a circumferentially adjacent two of the coils 26. This layout enables the stator 14 to be reduced in size in the axial direction.

When the first insulator retainers 52 of the first terminals 28 are fit in the first terminal sockets 44 of the insulator 22, the press-fit protrusions 58 of the first insulator retainers 52 are, as can be seen in FIGS. 3, 4, 5, 6, 7, 8, and 9, press-fit on the inner walls of the first terminal sockets 44, thereby minimizing misalignment of the first terminals 28 with the insulator 22 which usually arises from mechanical vibration of the motor 10.

When the second insulator retainer 74 of the second terminal 30 is fit in the second terminal socket 48 of the insulator 22, the press-fit protrusions 58 are press-fit on the inner wall of the side fit recess 48B, thereby minimizing misalignment of the second terminal 30 with the insulator 22 which usually rises from mechanical vibration of the motor 10. This ensures or improves the reliability in operation of the motor 10 against the mechanical vibration.

The coils 26 in this embodiment have the first ends 50A and the second ends 50B each of which, as illustrated in FIGS. 3 and 4, includes the first section 68, the second section 70, and the flexible section 72. The flexible section 72 works to minimize tension appearing at a corresponding one of the first ends 50A or the second ends 50B, thereby decreasing stress occurring in a joint of one of the coils 26 and a corresponding one of the first terminals 28 or the second terminal 30, which minimizes a risk of disconnection in the first ends 50A or the second ends 50B of the coils 26.

When the power supply connector 92 of the second connector 78 of each of the first terminals 28 is, as illustrated in FIG. 7, arranged on the power supply terminal 94, the second connector 78 is, as described above, elastically deformed or flexed in the second axial direction. Such flexing of the second connector 78 will result in concentration of mechanical stress on the first bend 82 and the second bend 86. The concentration of stress on the first bend 82 and the second bend 86 of the second connector 78 serves to minimize adverse effects of mechanical stress on the first connector 54 which is generated in the second connector 78 upon joining of the power supply connector 92 of the second connector 78 to the power supply terminal 94. This minimizes an increase in stress on the first connector 54 which results from vibration of the motor 10, thereby ensuring a required degree of resistance thereof to the vibration of the motor 10.

Each of the second connectors 78 is, as described above, designed to be discrete from a corresponding one of the first connectors 54. This layout contributes to elimination of adverse effects of mechanical stress, as generated in the second connector 78, on the first connector 54, thereby minimizing an increase in concentration of mechanical stress on the first connector 54 when the motor 10 vibrates.

The second connector 78 is, as described with reference to FIGS. 5 and 6, designed to have the second intermediate portion 88 finer or smaller in width than the first intermediate portion 67 of the first connector 54, thereby increasing mechanical stress acting on the second connector 78 when the power supply connector 92 of the second connector 78 is joined to the power supply terminal 94. This enhances the minimization of adverse effects of mechanical stress, as occurring in the second connector 78, on the first connector 54, which further reduces the stress acting on the first connector 54 when the motor 10 vibrates.

In a condition where the power supply connector 92 of the second connector 78 of each of the first terminals 28 is, as illustrated in FIG. 7, disposed in contact with the power supply terminal 94, the second connector 78 is flexed or elastically deformed in the first axial direction, thereby resulting in plastic deformation of the first bend 82. Such plastic deformation of the first bend 82 ensures stability in mechanical press acting on the contact between the power supply connector 92 of the second connector 78 of the first terminal 28 and the power supply terminal 94 when the power supply connector 92 and the power supply terminal 94 are welded together.

A major portion of the wide portion 90 of the second connector 78 and a major portion of the power supply connector 92 are, as can be seen in FIGS. 4 and 6, located at the same position as that of the crimp barrel 66 of the first connector 54 in the circumferential direction, in other words, aligned with the crimp barrel 66 in the radial direction of the stator core 20, thereby minimizing a distance between the first connector 54 and the second connector 78 of the first terminal 28.

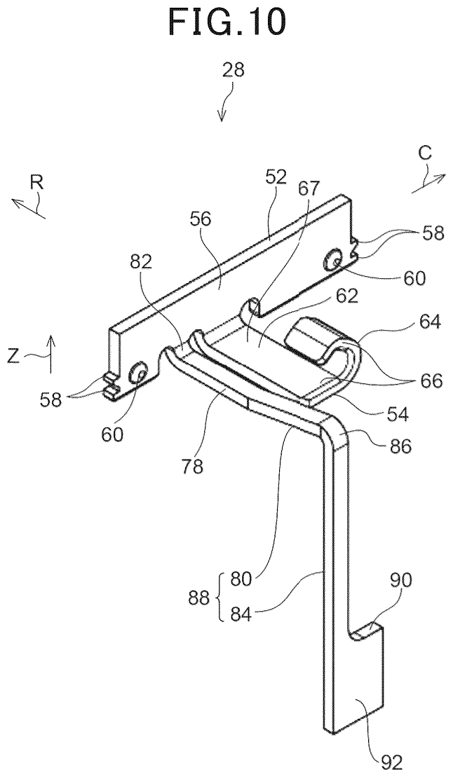

FIGS. 10 to 13 illustrate modified forms of the first terminals 28. Parts of the first terminals 28 substantially identical with those in the first embodiment are denoted by the same reference numbers as employed in the first embodiment, and explanation thereof in detail will be omitted here.

### First Terminal 28 of Motor in the Second Embodiment

Each of the first terminals 28 in the second embodiment illustrated in FIG. 10 is identical in structure with that of the motor 10 in the first embodiment (see FIG. 5) except that the power supply connector 92 is not bent, in other words, extends straight from the second leg 84 and the wide portion 90.

In the motor 10 in the second embodiment, when the power supply connector 92 of the second connector 78 of the first terminal 28 is disposed in contact with a power supply terminal, not shown, a mechanical load oriented in the radial direction will be exerted on the power supply connector 92 of the second connector 78, thus resulting in elastic deformation of the second connector 78 in the radial direction. Such deformation of the second connector 78 in the radial direction causes a mechanical stress to concentrate on the first bend 82 and the second bend 86. The exertion of the radial load on the power supply connector 92 of the second connector 78 causes the stress acting on the second bend 86 to be higher than that on the first bend 82.

The above-described structure of the first terminals 28, like in the first embodiment, serves to reduce an increase in stress on the first connector 54 when the motor 10 vibrates, thereby ensuring a required degree of resistance to the mechanical vibration of the motor 10.

### First Terminals 28 of Motors in the Second and Third Embodiments

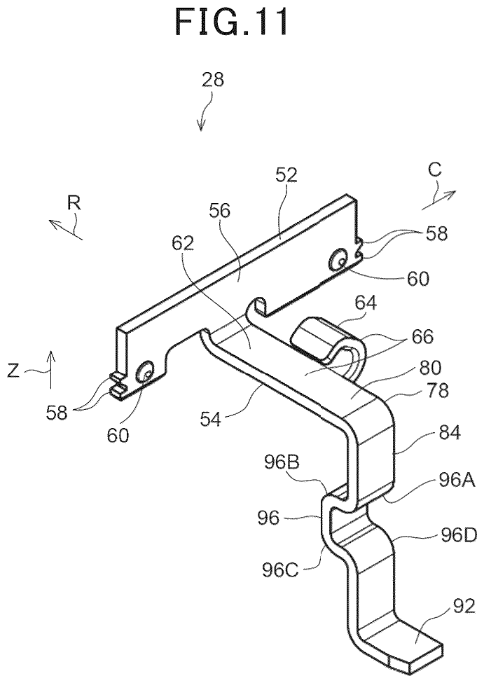

Each of the first terminals 28 of the motor 10 in the third embodiment, as illustrated in FIG. 11, has the second connector 78 which extends from the first connector 54 and is formed integrally with the first connector 54.

Specifically, the second connector 78 includes the first leg 80 which extends radially inward from a radially inner end of the base 62 of the first connector 54. The second connector 78 also includes the second leg 84 which extends in the second axial direction from a radially inner end of the first leg 80. The second leg 84 has the C- or U-shaped bent portion 96 formed in an axially central portion thereof. The bent portion 96 works as a stress concentrator and is shaped to have an opening facing radially inward. The bent portion 96 includes the L-shaped first bend 96A, the L-shaped second bend 96B, the L-shaped third bend 96C, and the L-shaped fourth bend 96D.

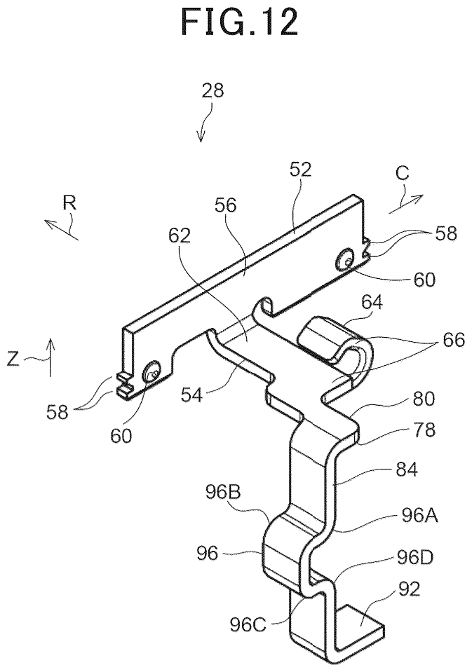

Each of the first terminals 28 of the motor 10 in the fourth embodiment is, as illustrated in FIG. 12, identical in structure with that in the third embodiment except that orientations of the second leg 84, the bent portion 96, and the power supply connector 92 are different from those in the third embodiment (see FIG. 11). Specifically, the first terminal 28 in the fourth embodiment has the bent portion 96 shaped to have an opening facing in the first circumferential direction.

In the motor 10 in each of the above-described third and fourth embodiments illustrated in FIGS. 11 and 12, the power supply connector 92 of the second connector 78 of the first terminal 28 is disposed in contact with a power supply terminal, not shown, the second connector 78 is flexed or elastically deformed in the axial direction. Such deformation of the second connector 78 results in concentration of stress on the bent portion 96. This structure serves to reduce adverse effects of mechanical stress, as generated in the second connector 78, on the first connector 54 when the power supply connector 92 of the second connector 78 is joined to a power supply terminal, not shown. This reduces an increase in stress on the first connector 54 when the motor 10 mechanically vibrates and ensures a required degree of resistance of the first terminal 28 to the vibration of the motor 10.

### First Terminal 28 of Motor in the Fifth Embodiment

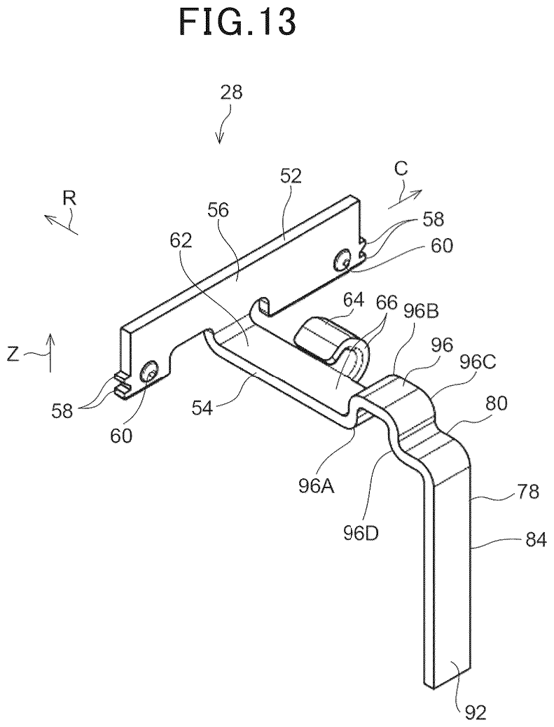

Each of the first terminals 28 of the motor 10 in the fifth embodiment is, as can be seen in FIG. 13, identical in structure with that in the third embodiment except that the first leg 80 has the bent portion 96 formed by a radially central portion thereof, and the power supply connector 92 extends straight from the second leg 84 without being bent. The bent portion 96 is shaped to have an opening facing in the second axial direction. The structure of the first terminals 28 in the fifth embodiment, like in the above embodiment, serves to reduce an increase in mechanical stress acting on the first connector 54 when the motor 10 vibrates and ensure a require degree of resistance to the vibration of the motor 10.

This disclosure is not limited to the above embodiments and modifications, but may be realized by various embodiments without departing from the purpose of the disclosure. For instance, the structure of the motor 10 may be used for an electrical generator. The structure of the motor 10 may be employed in an outer-rotor brushless motor in which the rotor 12 is arranged radially outside the stator 14. The structure in this disclosure may also be used in a rotor equipped with an armature identical in structure with the stator 14.

This disclosure has referred to the above embodiments, but may be realized by various embodiments and equivalents without departing from the purpose of the disclosure. This disclosure includes all possible combinations of the features of the above embodiments and the modifications or features similar to the parts of the above embodiments and the modifications.

The above embodiments realize the following unique structures.

### First Structure

An armature (14) is provided which comprises: an armature core (20) which includes teeth (34) arranged at intervals away from each other in a circumferential direction of the armature; an insulator (22) secured to the armature core; a plurality of coils (26) each of which is made of a winding of a conductive wire (24) around a respective one of the teeth; and a terminal (28) which is made from elastic conductive material and includes an insulator retainer (52) secured to the insulator, a first connector (54), and a second connector (78). The first connector extends from the insulator retainer and includes a crimp (66) to which a coil end (50A) of the coils is secured. The second connector includes a power supply connector (92) which extends from one of the insulator retainer and the first connector and is connected to a power supply connector (92). The second connector also includes a stress concentrator (82, 86, 96) on which stress concentrates in a condition where the power supply connector is connected to a power supply.

### Second Structure

The armature, as set forth in the above first structure, wherein the second connector extends from the insulator retainer and is discrete from the first connector.

### Third Structure

The armature, as set forth in the above first structure, wherein the second connector extends from the first connector and is formed integrally with the first connector.

### Fourth Structure

The armature, as set forth in the above second structure, wherein the first connector includes a first intermediate portion (67) arranged between the crimp and the insulator retainer. The second connector includes a second intermediate portion (88) which is arranged between the power supply connector and the insulator retainer or between the power supply connector and the first connector. The second intermediate portion is shaped to be finer or thinner than the first intermediate portion.

### Fifth Structure

The armature, as set forth in any one of the above second to fourth structures, wherein at least a portion of the crimp and at least a portion of the power supply connector are aligned with each other in a radial direction of the armature.

### Sixth Structure

The armature as set forth in any one of the above first to fifth structures, wherein the first connector and the second connector are arranged between a circumferentially adjacent two of the coils.

### Seventh Structure

The armature, as set forth in any one of the above first to sixth structures, wherein the stress concentrator is plastically deformed with the power supply connector being connected to a power supply.

### Eighth Structure

The armature, as set forth in any one of the above first to seventh structures, wherein the insulator includes a terminal coupling (44) to which the insulator retainer is secured. The insulator retainer has portions shaped as press-fit portions (58) which are press-fit in the terminal coupling.

### Ninth Structure

The armature, as set forth in the above eighth structure, wherein the press-fit portions are located at portions of the insulator retainer which are arranged at circumferentially opposed sides of the first connector and the second connector.

### Tenth Structure

A rotating electrical machine (10) is provided which comprises: a first one of a stator (14) and a rotor (12) which includes the armature as set forth in any one of the above first to ninth structures; and a second one of the stator and the rotor which includes a magnet (18) radially facing the armature.

1. An armature comprising:
an armature core which includes teeth arranged at intervals away from each other in a circumferential direction of the armature;
an insulator secured to the armature core;
a plurality of coils each of which is made of a winding of a conductive wire around a respective one of the teeth; and
a terminal which is made from elastic conductive material and includes an insulator retainer secured to the insulator, a first connector, and a second connector, the first connector extending from the insulator retainer and including a crimp to which a coil end of the coils is secured, the second connector including a power supply connector which extends from one of the insulator retainer and the first connector and is connected to a power supply connector, the second connector also including a stress concentrator on which stress concentrates in a condition where the power supply connector is connected to a power supply.

2. The armature as set forth in claim 1, wherein the second connector extends from the insulator retainer and is discrete from the first connector.

3. The armature as set forth in claim 1, wherein the second connector extends from the first connector and is formed integrally with the first connector.

4. The armature as set forth in claim 2, wherein the first connector includes a first intermediate portion arranged between the crimp and the insulator retainer,
the second connector includes a second intermediate portion which is arranged between the power supply connector and the insulator retainer or between the power supply connector and the first connector,
the second intermediate portion is shaped to be finer than the first intermediate portion.

5. The armature as set forth in claim 2, wherein at least a portion of the crimp and at least a portion of the power supply connector are aligned with each other in a radial direction of the armature.

6. The armature as set forth in claim 1, wherein the first connector and the second connector are arranged between a circumferentially adjacent two of the coils.

7. The armature as set forth in claim 1, wherein the stress concentrator is plastically deformed with the power supply connector being connected to a power supply.

8. The armature as set forth in claim 1, wherein the insulator includes a terminal coupling to which the insulator retainer is secured,
the insulator retainer has portions shaped as press-fit portions which are press-fit in the terminal coupling.

9. The armature as set forth in claim 8, wherein the press-fit portions are located at portions of the insulator retainer which are arranged at circumferentially opposed sides of the first connector and the second connector.

10. A rotating electrical machine comprising:
a first one of a stator and a rotor which includes the armature as set forth in claim 1; and
a second one of the stator and the rotor which includes a magnet radially facing the armature.
